(19) United States
(12) Patent Application Publication
(10) Pub. No.: US 2015/0290589 A1
(43) Pub. Date: Oct. 15, 2015

(54) ENCAPSULATING OUTER SHELL FOR MEMBRANE ELEMENTS

(71) Applicant: Parker-Hannifin Corporation, Cleveland, OH (US)

(72) Inventor: Rick Hoffman, Torrance, CA (US)

(21) Appl. No.: 14/680,433

(22) Filed: Apr. 7, 2015

Related U.S. Application Data
(60) Provisional application No. 61/978,211, filed on Apr. 11, 2014.

(51) Int. Cl. B01D 61/08

(52) U.S. Cl. CPC B01D 61/08

(57) ABSTRACT

A reverse-osmosis separator module includes a pre-formed shell housing having a longitudinal axis extending between opposite ends and defining an inner chamber. A reverse-osmosis separator element is telescopically disposed in the inner chamber, and includes a permeate tube extending along the longitudinal axis and a membrane construction spirally wound around the permeate tube. An end cap is located at each end of the pre-formed shell housing.

### RELATED APPLICATIONS

This application claims the benefit of U.S. Provisional Application No. 61/978,211 filed Apr. 11, 2014, which is hereby incorporated herein by reference in its entirety.

### FIELD OF INVENTION

The present invention relates generally to reverse-osmosis separator modules, and more particularly to spiral-wound separator elements encapsulated in an outer shell for pressurized liquid-separation processes.

### BACKGROUND

Reverse-osmosis (RO) is a separation technique that is suitable for a wide range of applications. For example, RO membranes are used in water purification processes to remove salts and other effluent from seawater or brackish water solutions. In a typical RO purification process, an RO separator module having an RO membrane is placed in a pressure vessel in which a supply of feed liquid (e.g., seawater) is pressurized against one side of the membrane. The RO membrane rejects the solutes in the feed liquid (e.g., salt and other effluent) to produce a concentrate liquid on the one side, and enables transport of a solute-free permeate liquid (e.g., salt-and-effluent-free water) across the membrane to the other side. The permeate liquid and concentrate liquid are each collected from the RO separator module through separate flow paths.

A common RO membrane configuration in water treatment applications is a spiral-wound RO separator element. In the spiral-wound configuration, a flat sheet membrane construction is wound around a permeate collection tube, in which flow paths are provided in the membrane construction for flow of the liquids. An RO module casing, or shell, is formed around the outer body of the spiral wound membrane construction in order to encapsulate the RO separator element. Current RO module shells are formed by winding fiberglass coated in uncured liquid resin around the spiral-wound RO separator element, which is then cleaned of excess resin and thermally cured. The handling of the fiberglass and liquid resin is not an environmentally or employee-friendly process, and the equipment required to mix and pump the liquid resin, apply the fiberglass, and heat cure the composite adds unnecessary time and costs to the end product. The liquid resin also results in dimensional variation of the shell outer diameter, which causes rejection of parts that are undersized, oversized, or have an unacceptable appearance.

### SUMMARY OF INVENTION

The present invention provides a pre-formed shell housing for a spiral-wound RO separator element, which replaces the process of applying fiberglass and liquid resin to the RO separator element, thus enabling faster processing times and reduced labor costs, reduced material and equipment costs, reduced process variation and improved quality control, and/or an improved environmentally-friendly process. The selection of a suitable material for the pre-formed shell housing may also reduce corrosion or degradation by the feed liquid, may provide chemical inertness for U.S. Department of Agriculture (USDA) and U.S. Food and Drug Administration (FDA) approval, and may provide enhanced lateral strength for withstanding forces exerted on the shell housing.

According to one aspect of the invention, a reverse-osmosis separator module includes a pre-formed shell housing having a longitudinal axis extending between opposite ends and defining an inner chamber. A reverse-osmosis separator element is telescopically disposed in the inner chamber, and includes a permeate tube extending along the longitudinal axis and a membrane construction spirally wound around the permeate tube. An end cap is located at each end of the pre-formed shell housing.

Embodiments of the invention may include one or more of the following additional features. That is, the spiral-wound RO membrane construction may include axial and radial flow paths, and a semi-permeable membrane. The axial flow paths may be provided for enabling the feed liquid to enter the membrane construction at one end of the reverse-osmosis separator element, and the semi-permeable membrane is configured for separating the feed liquid into permeate liquid and concentrate liquid. The axial flow paths may also enable the concentrate liquid to exit the reverse-osmosis separator element at an opposite end, and the radial flow paths may enable the permeate liquid to pass to the permeate tube and exit the reverse-osmosis separator element through the permeate tube at either end.

Further optional features additionally include the spiral-wound membrane construction forming a membrane construction body portion with an outer surface, and the pre-formed shell housing having an interior surface that may be so dimensioned for receiving the RO separator element, such that the outer surface of a membrane construction body portion engages the shell housing interior surface, such as with a slip-fit tolerance, for reducing bypass of the feed liquid and/or reducing interruption of the membrane construction flow paths. The shell housing may be configured as a cylindrical tube having a major body portion with the interior surface forming a uniform inner diameter along the longitudinal axis. The shell housing may also have an outer surface which forms a wall thickness between the inner surface and outer surface, and the wall thickness may be so dimensioned for withstanding forces exerted on the shell housing without failure when the reverse-osmosis separator module is operating under pressure and/or if the reverse-osmosis separator element swells and compresses against the shell housing.

In yet other embodiments of the invention, the pre-formed shell housing may be made from metals, thermoplastics, composites, or other rigid materials capable of withstanding corrosion and degradation by the feed liquid. A suitable material may also be selected for withstanding the forces exerted on the shell housing during operation. For example, the shell housing may be made of polypropylene, which provides chemical inertness and may facilitate FDA approval. The polypropylene shell housing may have a wall thickness between 0.125 inches to 0.250 inches for providing sufficient lateral strength and burst strength when the RO separator module is subjected to forces during pressurized liquid-separation, such as high-pressure seawater desalination.

Still other embodiments of the invention may have the respective end caps of the RO separator module each including an end wall disposed transverse to the longitudinal axis of the shell housing, and the respective end walls may have through-passages for enabling fluid to enter or exit the inner chamber. The through-passages may be configured as a plurality of vanes and/or may also be configured for receiving the permeate tube of the RO separator element. The respective end caps may further include side surfaces having outer annular grooves for securing the RO separator module in a pressure vessel and/or for engaging a seal member, such as a brine seal, in the pressure vessel. The respective end caps may be affixed to the pre-formed shell housing by thermal welding, sonic welding, adhesive bonding, threading, and/or other attachment means. One of the end caps may be integrally formed and unitary with the pre-formed shell housing.

Further in accordance with the invention, a plurality of RO separator modules may be employed in a pressure vessel for the liquid-separation process. As such, at least one of the RO separator module end caps may be configured for operatively connecting in series with an end cap of another similar RO separator module.

In other embodiments, the at least one end cap for the first-mentioned RO separator module may be the same end cap for the other similar RO separator module for interconnecting the respective RO separator modules in series. The end cap interconnecting the RO separator modules may be threaded on both ends, or may have other attachment means for attaching to the respective RO separator modules. The end caps being attachable to the pre-formed shell housing may promote modularity in the liquid-separation system design.

According to another aspect of the invention, a reverse-osmosis separator module for separating feed liquid into permeate liquid and concentrate liquid includes a pre-formed shell housing having a longitudinal axis and an interior surface defining an inner chamber that extends between an inlet end and an outlet end. A reverse-osmosis separator element having a membrane construction body portion extending between the inlet end and the outlet end is disposed in the inner chamber, wherein the membrane construction body portion has an outer surface that engages the interior surface of the shell housing for encapsulating the membrane construction body portion and reducing bypass of the feed liquid. An inlet end cap and an outlet end cap are affixed at respective ends of the shell housing, and each of the end caps have an outer face disposed transverse to the longitudinal axis. The outer face of the inlet end cap has openings for enabling the feed liquid to enter the inner chamber, and the outer face of the outlet end cap has openings for enabling the concentrate liquid to exit the inner chamber. The inlet end cap and/or the outlet end cap may have separate openings for enabling the permeate liquid to exit the inner chamber.

According to yet another aspect of the invention, a method for assembling a reverse-osmosis membrane module is provided, which includes the steps of: obtaining a pre-formed tubular shell housing having a wall thickness and a uniform inner diameter along a longitudinal axis; affixing a first end cap to one end of the pre-formed shell housing; telescopically inserting a spiral-wound reverse-osmosis separator element into the pre-formed shell housing with a slip-fit tolerance using hand pressure; and affixing a second end cap to an opposite end of the pre-formed shell housing.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a cross-sectional side view of an exemplary reverse-osmosis separator module according to the invention that is taken about the line 2-2 in FIG. 4;

FIG. 2 is an enlargement of detail 2 in FIG. 1;

FIG. 3 is a close-up side elevational view of one end of the reverse-osmosis separator module in FIG. 1;

FIG. 4 is an end view of the separator;

FIG. 5 is a side elevational view of an exemplary combination of two reverse-osmosis separator modules according to the invention;

FIG. 6 is a side elevational view of another exemplary combination of two reverse-osmosis separator modules according to the invention;

FIG. 7 is a side elevational view of yet another exemplary combination of two reverse-osmosis separator modules according to the invention;

FIGS. 8A-8C are perspective views showing an exemplary method for assembling a reverse-osmosis separator module according to the invention;

FIG. 9 is a cross-sectional side view showing an exemplary operation of a reverse-osmosis separator module according to the invention.

### DETAILED DESCRIPTION

The principles of the present invention have particular application for reverse-osmosis separator modules used in pressurized liquid-separation processes, such as seawater desalination for industrial application, and thus will be described below chiefly in this context. It will of course be appreciated, and also understood, that principles of this invention may be applicable to other liquid-separation processes, such as seawater or brackish water desalination for producing drinking water, or for the concentration of food liquids, such as fruit juices or dairy-products. In addition, the principles of this invention may be used in the production of ultrapure water for the semi-conductor or pharmaceutical industries, for wastewater and waste reuse treatments, or any similar liquid-separation processes.

Turning to FIG. 1, an exemplary reverse-osmosis (RO) separator module 10 is shown. The RO separator module 10 includes a pre-formed shell housing 20, a reverse-osmosis separator element 40, and end caps 60, 80 located at each end of the pre-formed shell housing 20. The pre-formed shell housing 20 has a longitudinal axis 21 extending between opposite ends 27, 29, and also includes an interior surface 23 that defines an inner chamber in which the RO separator element 40 is telescopically disposed.

The RO separator element 40 may include a variety of separation mediums, such as membrane-based (e.g., spiral-wound or hollow fiber) separation mediums. A suitable type of membrane construction may be selected in a well-known manner for providing the desired flow rate, permeate flux, solute rejection, and other factors. For example, the membrane construction may include a semi-permeable membrane configured for separating a feed liquid into a permeate liquid (which passes through the membrane) and a concentrate liquid (which contains the solutes rejected by the membrane). The semi-permeable membrane may include ultrafiltration membranes or microfiltration membranes of a suitable type, such as thin film composite membranes. Representative semi-permeable membranes include those made from polysulfones, polyether sulfones, polyamides, polyacrylonitrile, polyfluroethylines, cellulose ester, and the like.

In a preferred embodiment, the RO separator element 40 includes a membrane construction 41 spirally wound around a permeate collection tube 43 that extends along the longitudinal axis 21. The spiral-wound membrane construction 41 may include axial flow paths for enabling the feed liquid to enter the membrane construction 41 at one end 47 (e.g., toward an inlet end 27) of the RO separator element 40, and for enabling the concentrate liquid to exit the RO separator element 40 at an opposite end 49 (e.g., toward an outlet end 29). The spiral-wound membrane construction 41 may also include radial flow paths, such as in the radial-spiral direction, which enables the permeate liquid to pass to the permeate tube 43, through permeate tube passages, and then exit the RO separator element 40 toward either end 27, 29.

The membrane construction 41 may be formed as a flat-sheet construction having the semi-permeable membrane layer interposed between a feed channel layer for enabling the axial flow paths and a permeate collection layer for enabling the radial flow paths. The feed channel layer may be formed as a biplanar extruded net, and the permeate collection layer may be formed from a tricot woven fabric, such as polyester. The spiral-wound membrane construction 41 may include one or more spiral wraps around the permeate collection tube 43, thus forming a membrane construction body portion 45 that extends along the longitudinal axis 21 between opposite ends 47, 49, and has an outer surface 46.

The pre-formed shell housing 20 may be made from pre-fabricated piping, tubing, or any pre-formed tubular member with an inner chamber that can be sized for encapsulating the RO separator element 40. In a preferred embodiment the pre-formed shell housing 20 is a cylindrical tube having a major body portion with the interior surface 23 forming a uniform inner diameter along the longitudinal axis 21. In this manner, the inner diameter may be continuously uniform along the entire length of the shell housing 20; or the shell housing 20 may have outwardly or inwardly tapered sections toward respective ends 27, 29, that may facilitate the telescopic insertion and/or containment of the RO separator element 40. The pre-formed shell housing 20 also has an outer surface 25 that may define an outer diameter of the cylindrical shell housing 20. The outer diameter may also be continuously uniform along the major body portion of the shell housing 20.

The distance between the shell housing outer surface 25 and shell housing interior surface 23 defines a shell housing wall thickness, which may also be uniformly thick along the major body portion of the shell housing 20 for enabling even distribution of stresses when the RO separator module 10 is subjected to forces during operation. For example, as described in further detail below, the RO separator module 10 may be placed in a separate pressurized vessel that forces the feed liquid against the semi-permeable membrane for effecting the liquid-separation process. The pressure exerted by the pressure vessel is typically greater than the osmotic pressure of the feed liquid, which may be between 10-600 psi for purification of fresh and brackish waters, or between 600-1200 psi for desalination of seawater. The membrane construction body portion 45 may also exert pressure on the shell housing interior surface 23 as the membrane construction body portion 45 swells in the radial dimensions. The membrane construction body portion 45 may swell when liquids flow through the membrane construction 41 and as pressure is applied to the liquids, or when the membrane construction 41 interacts with certain ions or chemicals.

So as to withstand the forces exerted on the shell housing 20 without failure (e.g. without exceeding the yield strength or causing plastic deformation), the shell housing 20 may be made from suitable materials, such as metals, plastics or composites having sufficient lateral and burst strength. The materials selected for the shell housing 20 may also be capable of withstanding corrosion and degradation by the feed liquid. For example, suitable metals may include stainless steels or copper-alloys; suitable plastics may include polypropylene, polyethylene, ABS, PVC, or similar plastics; and suitable composites may include fiberglass reinforced epoxy, or the like. Other rigid materials (e.g. having a hardness similar to or greater than polypropylene) may also be utilized. In a preferred embodiment, the shell housing may be made of polypropylene, which provides chemical inertness and may facilitate USDA and FDA approval of the purified liquid. The polypropylene shell housing may have a wall thickness between 0.100 inches to 0.300 inches, or more preferably 0.125 inches to 0.250 inches, for providing sufficient strength during pressurized liquid-separation, such as high-pressure seawater desalination.

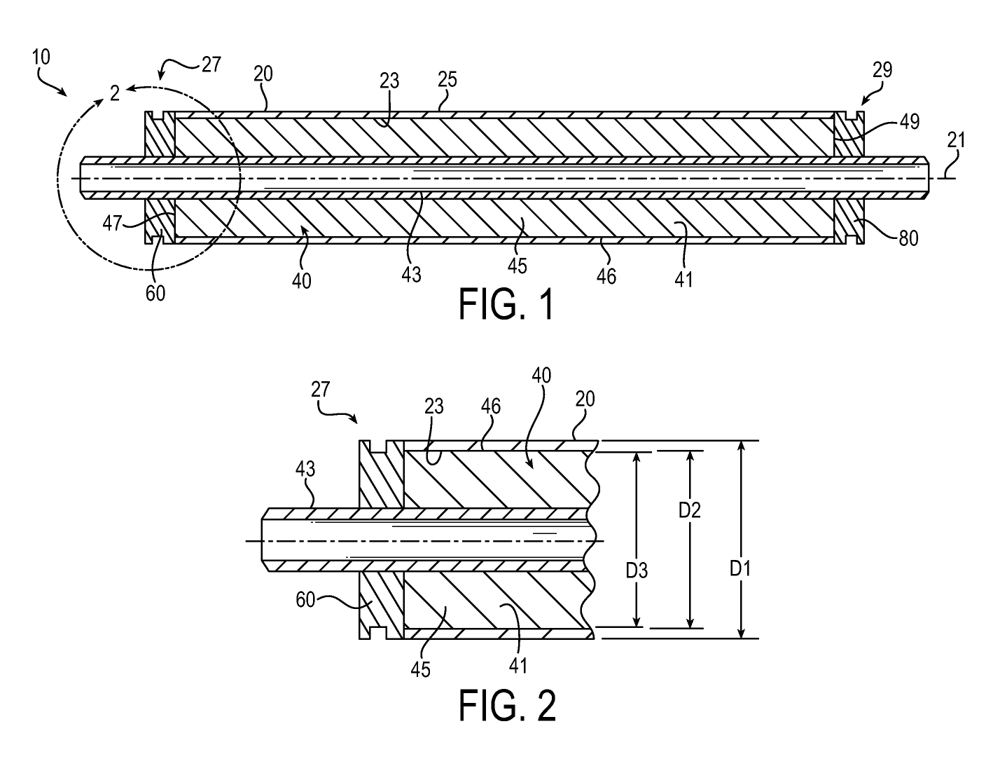

Turning to FIG. 2, a close-up view of the RO separator module 10 illustrates the fitment between the pre-formed shell housing 20 and the RO separator element 40. According to a preferred aspect of the invention, the shell housing interior surface 23 may be so dimensioned for telescopically receiving the RO separator element 40 with a slip-fit tolerance, such that the outer surface 46 of the membrane construction body portion 45 engages the shell housing interior surface 23. In this manner, the shell housing 20 encapsulates the RO separator element 40, and the resulting engagement of respective surfaces 23, 46 may reduce bypass of the feed liquid (e.g., reduce passage of the feed liquid through an annulus formed between the shell housing interior surface 23 and the membrane construction outer surface 46). The shell housing interior surface 23 may also be so dimensioned with a slip-fit tolerance for enabling ease of installation of the RO separator element 40, such as by using moderate pressure (e.g., hand pressure) for telescopic insertion. The slip-fit tolerance may also provide sufficient spacing for reducing compressive forces on the membrane construction body portion 45 when the RO separator element 40 is inserted into the shell housing 20, thus reducing compression of the membrane construction 41 flow paths, which could interrupt flow rates and performance of the RO separator element 40 during operation.

The slip-fit tolerance between the shell housing interior surface 23 and the outer surface 46 of the membrane construction body portion 45 may be between 0.001 inches and 0.050 inches, or more particularly between 0.001 inches and 0.020 inches. For example, referencing FIG. 2, a standard 2.5 inch RO separator module 10 may have an outer diameter (D1) between about 2.4 inches and 2.6 inches, preferably about 2.5 inches; an inner diameter (D2) between about 2.3 inches and 2.5 inches, preferably about 2.4 inches; and an outer diameter (D3) of the membrane construction body portion 45 between about 2.3 inches and 2.4 inches, preferably about 2.35 inches; all values and subranges of which may have a dimensional tolerance of plus or minus 10%. These dimensions may be scaled for 1 inch, 4 inch, 8 inch, 16 inch, 24 inch, etc. RO separator modules 10, including all values and subranges therebetween and thereafter.

The shell housing interior surface 23 may also be so dimensioned for accommodating swelling of the membrane construction body portion 45 during operation, or over the life of the RO separator module 10. For example, the membrane construction body portion 45 may swell in the radial direction between 0.5% to 5%, which may cause the membrane construction body portion 45 to compress against the shell housing interior surface 23, which could interrupt the membrane construction 41 flow paths. As such, the shell housing inner diameter (D2) may be sized between 0.5% to 5% greater, more preferably between 0.5% to 2% greater, than the outer diameter (D3) of the membrane construction body portion 45.

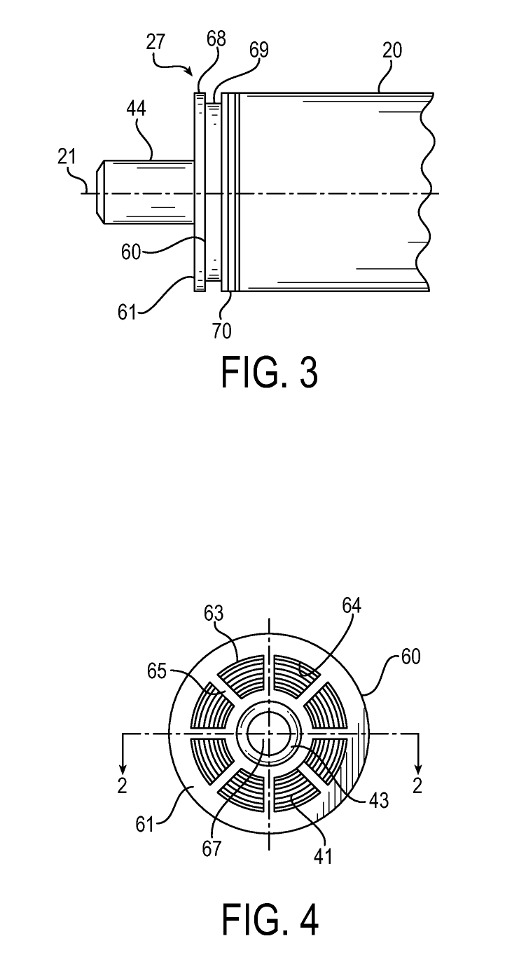

Turning to FIGS. 3 and 4, the end cap 60 is shown as being disposed concentrically about the end 27 of shell housing 20. The end cap 60 includes an outer face 61 that is disposed transverse to the longitudinal axis 21. The outer face 61 may form one side of the end cap 60 and an inner face (not shown) may form an opposite side, with an end wall being formed therebetween. The outer face 61 has openings 63 and the end wall has through passages 64 for enabling liquid communication between the outside and inside of the shell housing 20. The end cap 60 may be an inlet end cap in which feed liquid may flow through the passages 63 and enter the shell housing 20 inner chamber. The end wall (or outer face 61) may also have a through passage 67 (or opening) for enabling the permeate liquid to enter or exit the shell housing 20. The through passage 67 may be configured for receiving an end portion 44 of the permeate collection tube 43. The opposite end cap 80 located at the opposite end 29 may have all of the same features as the inlet end cap 60. The opposite end cap 80 may be considered an outlet end cap in which the concentrate fluid may exit the shell housing 20 through similar passages 63. The permeate fluid may enter or exit the inner chamber of the shell housing 20 through the permeate tube 43 at either end 60, 80; or the permeate through passage 67 may be provided at only one of the ends.

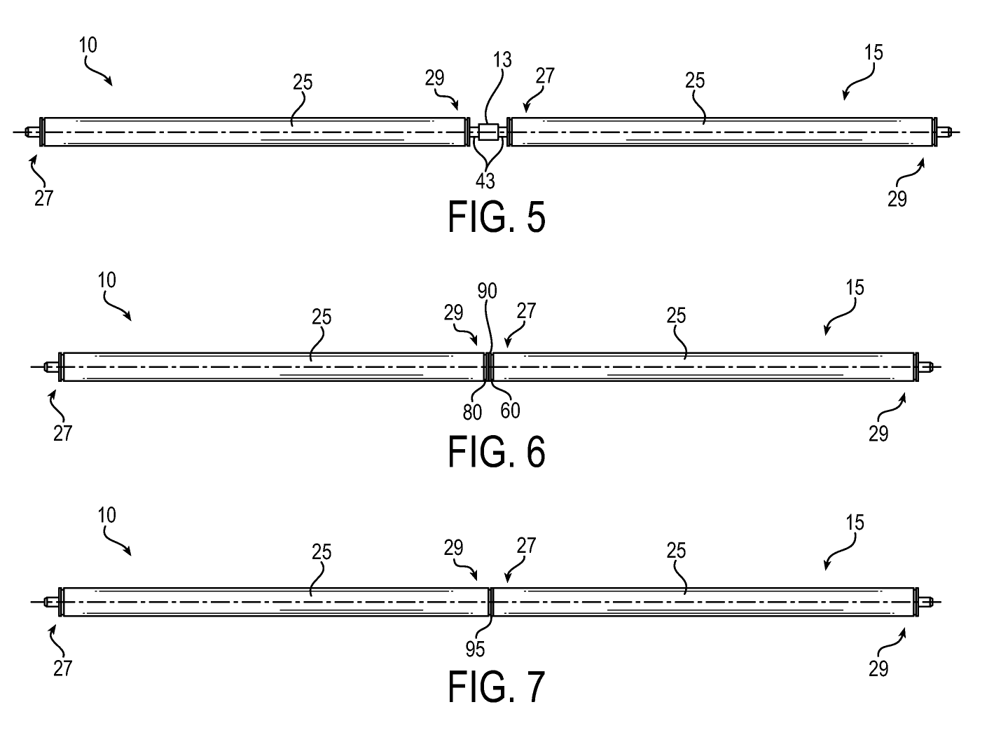

The end caps 60, 80 may also provide for confining the membrane construction body portion 45 inside of the shell housing 20, and may prevent telescoping (relative axial movement) of the spiral-wound membrane construction 41 sheets. The end cap through passages 63 may be formed between a plurality of vanes having radial cross-members 65 for enabling liquid passage and for confining the membrane construction body portion 45 to inside the shell housing 20. The end caps 60, 80 may also have a side surface 68 transverse to the end face 61. As shown in FIG. 3, the side surface 68 may have an outer annular groove 69 for engaging with an annular seal member, such as a brine seal, as discussed below. The end caps 60, 80 may be affixed to the shell housing 20 by suitable attachment means. For example, the end caps 60, 80 may be welded or adhered to the shell housing 20 at a bond line 70, such as by thermal welding, sonic welding, and/or adhesive bonding. The end caps 60, 80 may also be threaded into or onto the shell housing 20. In an embodiment, one of the end caps (e.g., outlet end cap 80) may be integrally formed with the pre-formed shell housing 20, such that only one end of the shell housing 20 (e.g., inlet end 27) is capable of telescopically receiving the RO separator element 40. The end caps 60, 80 being attachable to the pre-formed shell housing 20 may promote modularity in the liquid-separation system design. For example, different styles of end caps 60, 80 may be affixed to different ends 27, 29 of the RO separator module 10 during fabrication; or the end caps 60, 80 may be affixed just before the RO separator module 10 is installed in the pressure vessel for operation. For example, FIG. 5 illustrates the RO separator module 10 combined in series with another similar RO separator module 15, such that the respective permeate collection tubes 43 are operatively connected via a coupler 13. Turning to FIG. 6, the combination of RO separator modules 10, 15 in series may also be accomplished by having the outlet end cap 80 of the first RO separator module 10 configured for operatively connecting with the inlet end cap 60 of the second RO separator module 15. The respective end caps 60, 80 may be coupled by threads or interlocking means 90. As shown in FIG. 7, the outlet end cap 95 of the first RO separator module 10 may be the same end cap for connecting with the inlet end 27 of the second RO separator module 15. The connecting end cap 95 may be threaded at each end for attaching to the respective RO separator modules 10, 15.

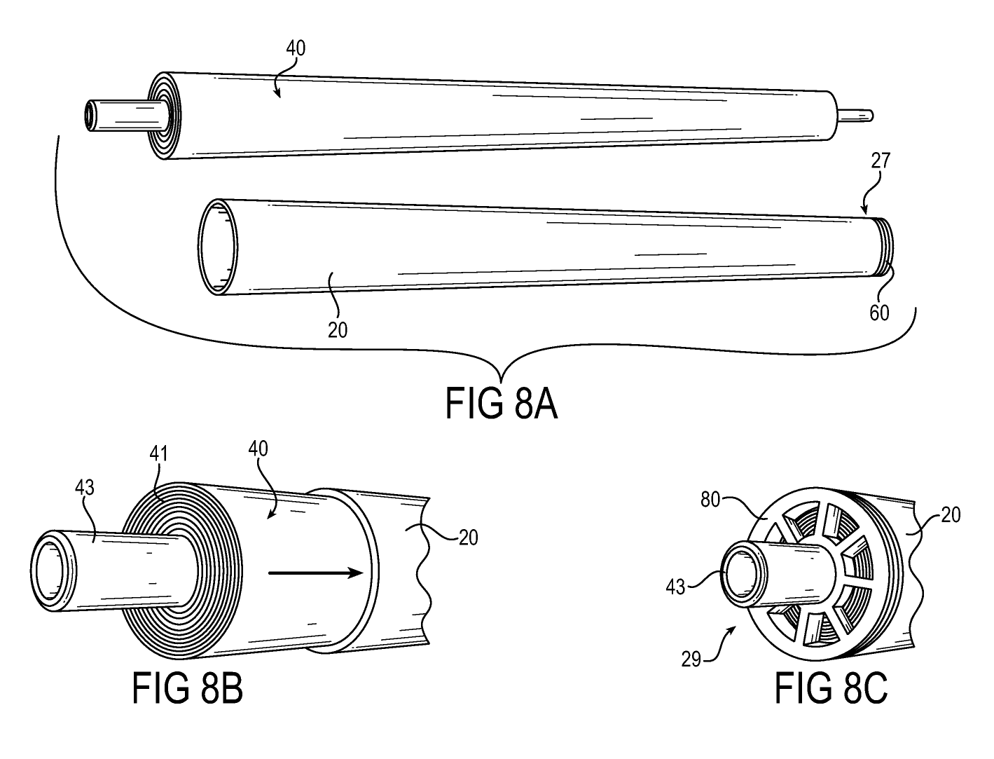

Turning to FIGS. 8A-8C, an exemplary method for assembling the RO separator module 10 is shown. In FIG. 8A, a pre-formed tubular shell housing 20 and a spiral-wound RO separator element 40 are each obtained. In FIG. 8A, a first end cap 60 is shown as being affixed to one end 27 of the shell housing 20. In FIG. 8B, the spiral-wound RO separator element 40 is telescopically inserted into the inner chamber of the pre-formed shell housing 20 with a slip-fit tolerance by using hand pressure. Due to the snug fit between the RO separator element 40 and shell housing 20, the insertion step may be facilitated by pushing a free end of the RO separator element 40 against a hard surface while also rotating the housing in the direction of the spiral. When the RO separator element 40 is completely inserted into the shell housing 20, a second end cap 80 is affixed to the opposite end 29 of the shell housing 20, as shown in FIG. 8C.

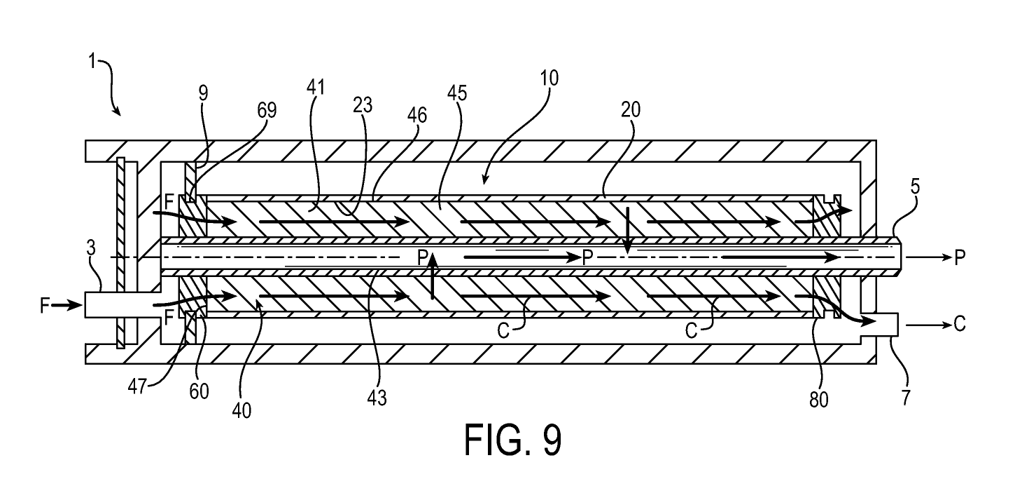

Turning to FIG. 9, an exemplary operation of the RO separator module 10 is illustrated. As discussed above, the RO separator module 10 may be placed in a pressure vessel 1 for effecting the RO liquid-separation process. The pressure vessel 1 has an inlet 3 for the feed liquid (F) to enter a chamber in the pressure vessel 1. A brine seal 9 engages the outer annular groove 69 of the RO separator module end cap 60 for preventing the feed liquid (F) from bypassing the RO separator module 10. The feed liquid (F) enters the inner chamber of shell housing 20 through the passages 63 in inlet end cap 60. The interior surface 23 of the shell housing 20 has a slip-fit tolerance with the outer surface 46 of the membrane construction body portion 45 and prevents bypass of the feed liquid (F). The feed liquid (F) enters the spiral-wound RO separator element 40 at an axial end 47 of the membrane construction body portion 45, and passes along axial flow paths in the membrane construction 41 formed by the feed channel layer. The pressure exerted by the pressure vessel 1 forces the feed liquid (F) against one side of the semi-permeable membrane, causing the permeate liquid (P) to transport across the semi-permeable membrane, and causing the solutes to be rejected to the concentrate liquid (C). The permeate liquid (P) passes through radial flow paths in the membrane construction 41 formed by the permeate collection layer, collects in the permeate collection tube 43, and then exits the shell housing 20 through the passage 67 in the outlet end cap 80. The concentrate liquid (C) passes through the axial flow paths in the membrane construction 41 and exits the shell housing 20 through passages 63 in the outlet end cap 80. The concentrate liquid (C) may exit the pressure vessel 1 through outlet 7 after a single pass, or the concentrate liquid (C) may be used as feed liquid (F) for further purification in subsequent downstream RO separation modules that are combined in series, as described above with reference to FIGS. 5-7. The permeate fluid (P) may exit the pressure vessel 1 through outlet 5, or it may pass through the permeate tube 43 of a sequentially combined RO separator module.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A reverse-osmosis separator module for separating feed liquid into permeate liquid and concentrate liquid, said reverse-osmosis separator module comprising:
a pre-formed shell housing defining an inner chamber and having a longitudinal axis extending between opposite ends;
a reverse-osmosis separator element telescopically disposed in the inner chamber of said pre-formed shell housing, said reverse-osmosis separator element including a permeate tube extending along the longitudinal axis and a membrane construction spirally wound around said permeate tube; and
an end cap located at each end of said pre-formed shell housing.

2. The reverse-osmosis separator module according to claim 1, wherein said membrane construction comprises flow paths and a semi-permeable membrane,
wherein axial flow paths enable the feed liquid to enter the membrane construction at one end of the reverse-osmosis separator element,
wherein the semi-permeable membrane is configured for separating the feed liquid into permeate liquid and concentrate liquid, and
wherein the axial flow paths enable the concentrate liquid to exit the reverse-osmosis separator element at an opposite end, and radial flow paths enable the permeate liquid to pass to said permeate tube and exit the reverse-osmosis separator element at either end through the permeate tube.

3. The reverse-osmosis separator module according to claim 2, wherein said pre-formed shell housing is a cylindrical tube having a major body portion with a uniform inner diameter along the longitudinal axis.

4. The reverse-osmosis separator module according to claim 3, wherein said inner diameter of said shell housing is so dimensioned for receiving said reverse-osmosis separator element with a slip-fit tolerance for reducing bypass of the feed liquid and for reducing restriction of the flow paths when the membrane construction swells and compresses against the shell housing.

5. The reverse-osmosis separator module according to claim 4, wherein said spirally-wound membrane construction forms a membrane construction body portion extending along the longitudinal axis and having an outer diameter, and wherein the inner diameter of said shell housing is between 0.5% to 5% greater than the outer diameter of the membrane construction body portion for accommodating swelling of the membrane construction body portion.

6. The reverse-osmosis separator module according to claim 3, wherein said pre-formed shell housing has an outer diameter which forms a wall thickness between the inner diameter and outer diameter, wherein the wall thickness is so dimensioned for withstanding forces exerted on the shell housing without failure when said reverse-osmosis separator module is operating in a pressure vessel and/or when said reverse-osmosis separator element swells and compresses against the shell housing.

7. The reverse-osmosis separator module according to claim 3, wherein said pre-formed shell housing is selected from the group consisting of: polypropylene, polyethylene, ABS, PVC, and other rigid thermoplastics capable of withstanding corrosion and degradation by the feed liquid.

8. The reverse-osmosis separator module according to claim 6, wherein said pre-formed shell housing is polypropylene and the wall thickness is between 0.125 inches to 0.250 inches.

9. The reverse-osmosis separator module according to claim 1, wherein one of the end caps is located at an inlet end of the shell housing and the other end cap is located an outlet end of the shell housing, wherein each of the end caps has an end wall disposed transverse to the longitudinal axis of said shell housing, wherein the end wall of the inlet end cap has a through-passage for enabling the feed liquid to enter the inner chamber, and wherein the end wall of the outlet end cap has a first through-passage for enabling the concentrate liquid to exit the inner chamber and a second through-passage for enabling the permeate liquid to exit the inner chamber.

10. The reverse-osmosis separator module according to claim 9, wherein the inlet end cap opening and the outlet end cap first opening are each configured as a plurality of vanes having radial cross-members for reducing telescoping of the spiral-wound membrane structure.

11. The reverse-osmosis separator module according to claim 10, wherein the end wall of the inlet end cap further comprises a second through-passage configured for receiving an inlet portion of the permeate tube, and wherein the second through-passage of the outlet end cap is configured for receiving an outlet portion of the permeate tube.

12. The reverse-osmosis separator module according to claim 9, wherein each of the end caps is affixed to the shell housing by thermal welding, sonic welding, adhesive bonding and/or threading.

13. The reverse-osmosis separator module according to claim 9, wherein each of the end caps have a side surface with an outer annular groove.

14. The reverse-osmosis separator module according to claim 9, wherein one of the end caps is configured for operatively connecting with an end cap of another reverse-osmosis separator module that is similar to said first-mentioned reverse-osmosis separator module.

15. The reverse-osmosis separator module according to claim 14, wherein the one end cap of the first-mentioned reverse-osmosis separator module is configured for being the same end cap for the other similar reverse-osmosis separator module for interconnecting the respective reverse-osmosis separator modules in series.

16. The reverse-osmosis separator module according to claim 15, wherein the one end cap is threaded on both ends for attaching the one end cap to the respective reverse-osmosis separator modules.

17. The reverse-osmosis separator module according to claim 9, wherein one of the end caps is unitary with the pre-formed shell housing.

18. A reverse-osmosis separator module for separating feed liquid into permeate liquid and concentrate liquid, said reverse-osmosis separator module comprising:
a pre-formed shell housing having a longitudinal axis and an interior surface defining an inner chamber that extends between an inlet end and an outlet end;
a reverse-osmosis separator element disposed in the inner chamber, said reverse-osmosis separator element having a membrane construction body portion extending between the inlet end and the outlet end along the longitudinal axis, wherein the membrane construction body portion has an outer surface that engages the interior surface of said shell housing for encapsulating the membrane construction body portion and reducing bypass of the feed liquid; and
an inlet end cap and an outlet end cap affixed at respective ends of said shell housing, each of said end caps having an outer face disposed transverse to the longitudinal axis, wherein the outer face of said inlet end cap has openings for enabling the feed liquid to enter the inner chamber, and wherein the outer face of said outlet end cap has openings for enabling the permeate liquid and concentrate liquid to exit the inner chamber.

19. A method for assembling a reverse-osmosis membrane module comprising the steps:
obtaining a pre-formed tubular shell housing having a wall thickness and a substantially uniform inner diameter along a longitudinal axis;
affixing a first end cap to one end of said pre-formed shell housing;
telescopically inserting a spiral-wound reverse-osmosis separator element into said pre-formed shell housing with a slip-fit tolerance using hand pressure; and
affixing a second end cap to an opposite end of said pre-formed shell housing.
